(19) United States
(12) Patent Application Publication
(10) Pub. No.: US 2026/0264302 A1
(43) Pub. Date: Sep. 10, 2026

(54) EXTRUSION PRESS DEVICE AND INJECTION MOLDING MACHINE

(71) Applicant: UBE Machinery Corporation, Ltd., Ube-shi, Yamaguchi (JP)

(72) Inventors: Shiyou Nonoue, Ube-shi, Yamaguchi (JP); Mamoru Kawasaki, Nagoya-shi, Aichi (JP)

(73) Assignee: UBE Machinery Corporation, Ltd., Ube-shi, Yamaguchi (JP)

(21) Appl. No.: 18/993,456

(22) PCT Filed: Jul. 6, 2023
(86) PCT No.: PCT/JP2023/025091

§ 371 Date: Jan. 10, 2025

(30) Foreign Application Priority Data
Jul. 14, 2022 (JP) 2022-112917
Nov. 18, 2022 (JP) 2022-184545

(51) Int. Cl. B29C 45/77

(52) U.S. Cl. CPC B29C 45/77; B29C 2945/76498; B29C 2945/76658

(57) ABSTRACT

An extrusion press device includes an extrusion material, an extrusion mechanism extruding the extrusion material by hydraulic pressure, pump units including pumps supplying hydraulic fluid to the extrusion mechanism and motors driving the pumps, and a control device controlling the pump units, in which extrusion press device, in the plurality of pump units provided, the pumps are variable capacity types, correlation is established between a discharge pressure of the pumps and an allowable maximum discharge rate allowed per pumps, a pressure and discharge rate required when extruding the extrusion material by a desired extrusion speed are respectively deemed as the required pressure and required discharge rate, and the control device is made to increase the number of the pumps driven if the required discharge rate corresponding to the required pressure exceeds the allowable maximum discharge rate.

### CROSS-REFERENCE TO RELATED APPLICATIONS

This application is a US national stage filing under 35 U.S.C. § 371 of International Application No. PCT/JP 2023/025091, filed Jul. 6, 2023, which claims priority to Japanese Patent Application No. 2022-112917, filed Jul. 14, 2022, and Japanese Patent Application No. 2022-184545, filed Nov. 18, 2022, each of which is incorporated herein by reference in its entirety.

### TECHNICAL FIELD

This disclosure relates to an extrusion press device and injection molding machine.

### BACKGROUND

In the past, extrusion presses have been provided with pluralities of pumps. For example, in Japanese Unexamined Patent Publication No. 2020-192603, a plurality of pumps with respectively different discharge rates and pressures were provided. A suitable pump is selected in accordance with the discharge rate and pressure required for driving the extrusion material (extrusion speed). If the amount of hydraulic fluid required for driving the extrusion material is large, a plurality of pumps are driven.

However, when fixing an upper limit value of the discharge rates to prevent overload of the motors, even if the pressure is low and the load of the motors is not that high, sometimes the output per motor will be restricted by the fixed upper limit value of the discharge rates. In that case, even if there were excess power per motor, due to the restriction on the upper limit of the discharge rates, it was necessary to increase the number of pumps driven. That was inefficient. Further, Japanese Unexamined Patent Publication No. 2020-192603 does not describe a solution to the above problem.

It could therefore be helpful to suitably set the upper limit value of the discharge rates in an extrusion press device provided with a plurality of pumps and streamline the number of pumps driven to thereby reduce the consumed power.

### SUMMARY

Disclosed herein is an extrusion press device or an injection molding machine including an extrusion material or injection material, an extrusion mechanism or an injection device extruding or injecting the extrusion material or the injection material by hydraulic pressure, pump units including pumps supplying hydraulic fluid to the extrusion mechanism or the injection device and motors driving the pumps, and a control device controlling the pump units, in which extrusion press device or injection molding machine, in the plurality of pump units provided, correlation is established between a discharge pressure of each pump and an allowable maximum discharge rate allowed per each pump, a pressure and discharge rate required when extruding or injecting the extrusion material or injection material by a desired extrusion speed or desired injection speed are respectively deemed as the required pressure and required discharge rate, and the control device is made to increase the number of the pumps driven if the required discharge rate corresponding to the required pressure exceeds the allowable maximum discharge rate.

Accordingly, it is possible to streamline the number of pumps driven to achieve a reduction in the consumed power.

### BRIEF DESCRIPTION OF THE DRAWINGS

FIG. 1 is a cross-sectional view in the axial direction of an extrusion press device according to a first embodiment.

FIG. 2 is a graph showing a pressure waveform at an extrusion step.

FIG. 3 shows a hydraulic circuit of an extrusion press device.

FIG. 4 shows the configuration of control of the extrusion press device.

FIG. 5 shows a map of D1.

FIGS. 6A and 6B show a map of D2.

FIGS. 7A and 7B are views showing the numbers of pumps driven in the present application and a comparative example.

FIG. 8 is a graph showing a relationship of an extrusion speed and consumed power.

FIG. 9 shows an example of display of a monitor.

FIG. 10 is a cross-sectional view showing a general configuration of an injection molding machine according to a second embodiment.

FIG. 11 is a block diagram showing a configuration of a hydraulic supply device in the injection molding machine according to the second embodiment.

FIG. 12 is a block diagram showing a configuration of a molding machine controller in the injection molding machine according to the second embodiment.

FIG. 13 is a block diagram showing a configuration of a pressure control device showing the configuration of a molding machine controller in the injection molding machine according to the second embodiment.

FIG. 14 is a block diagram showing a configuration of a flow control part of a molding machine controller in the injection molding machine according to the second embodiment.

FIG. 15 is a block diagram of FIG. 11 showing a supply route of hydraulic fluid to an opening/closing cylinder in an opening step.

FIG. 16 is a block diagram of FIG. 11 showing a supply route of hydraulic fluid to a clamping cylinder in a clamping step.

FIG. 17 is a block diagram of FIG. 11 showing a supply route of hydraulic fluid to a metering motor in a metering step.

FIG. 18 is a block diagram of FIG. 11 showing a supply route of hydraulic fluid to an injection cylinder in an injection filling step.

FIG. 19 is a view clearly showing a fixed platen and a movable platen in an injection molding machine.

### REFERENCE SIGNS LIST

1 injection molding machine
2 movable mold
3 fixed mold
4 cavity
5 injection device
10 hydraulic actuator
11 opening/closing cylinder
12 clamping cylinder
13 injection cylinder
13A injection screw
13B heating tube
13C connecting shaft
13D piston
13E casing
14 metering motor
15 ejection cylinder
16 injection device movement cylinder
20 hydraulic supply device
21 first hydraulic fluid pressure source
22 second hydraulic fluid pressure source
23 third hydraulic fluid pressure source
24 fourth hydraulic fluid pressure source
25 merging piping
25A, 25A1, 25A2 branch pipe
25B branch pipe
25B1, 25B1, 25B2, 25B3 branch pipe
27 first switching part
28 second switching part
31 fixed platen
32 movable platen
50 molding machine controller
51 control value acquiring part
52 pressure control part
53 flow control part
54 command output part
55 switching control part
56 storage part
211 first discharge piping
214 swash plate
215 angle adjusting part
215A spring
215B angle adjustment use actuator
215C electromagnetic direction changing valve
216 angle detector
221 second discharge piping
231 third discharge piping
231A, 231B branch pipe
241 fourth discharge piping
241A, 241B branch pipe
521 pressure threshold value setting part
522 pressure command value generating part
523 pressure judging part
531 flow rate command value generating part
BPV2, BPV3, BPV4 backflow prevention valve
PC1 first pressure/flow controller
PC2 second pressure/flow controller
PC3 third pressure/flow controller
PC4 fourth pressure/flow controller
CV1, CV2, CV3, CV4, CV5 changeover valve
CV6, CV7, CV8, CV9, CV10, CV11 changeover valve
G gate
M1 first motor
SM2 second motor
SM3 third motor
SM4 fourth motor
HP1 first hydraulic pump
HP2 second hydraulic pump
HP3 third hydraulic pump
HP4 fourth hydraulic pump
FD1, FD2, FD3, FD4 flow rate command value
PD1, PD2, PD3, PD4 pressure command value
PS1 first pressure sensor
PS2 second pressure sensor
PS3 third pressure sensor
SC2 servo control circuit
SC3 servo control circuit
SC4 servo control circuit
101 extrusion press device
102 extrusion mechanism
103 billet (extrusion material)
104 die
105 control device
110 hydraulic pump device
U11 to U13 first to third pump units
P11 to P13 first to third pumps
M11 to M13 first to third motors
P14 tilt use pump
M14 tilt use motor
120 end platen
121 tie rod
122 cylinder housing
123 main cylinder
124 ram
125 side cylinder
125H head
125L rod
126 cross head
127 container
128 container cylinder
128H head
128L rod
129 stem
151 first storage part
152 second storage part
D1 map
D2 table
111 pressure sensor
505 monitor

### DETAILED DESCRIPTION

### First Embodiment

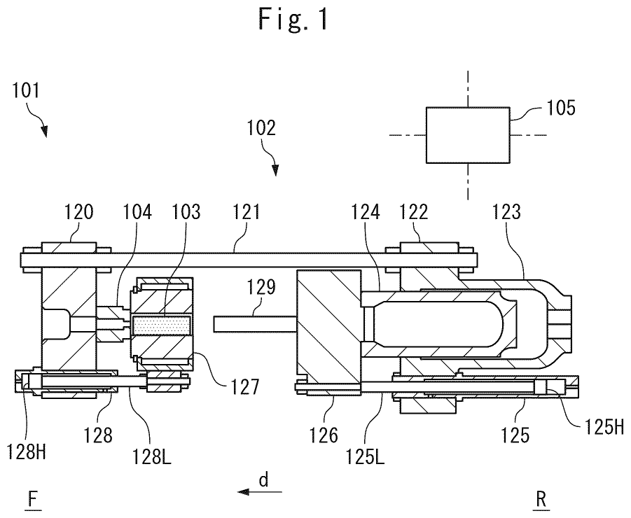

Below, referring to the attached figure, a first embodiment will be explained. FIG. 1 is a cross-sectional view in the axial direction (extrusion direction) of an extrusion press device 101.

### Overall Configuration

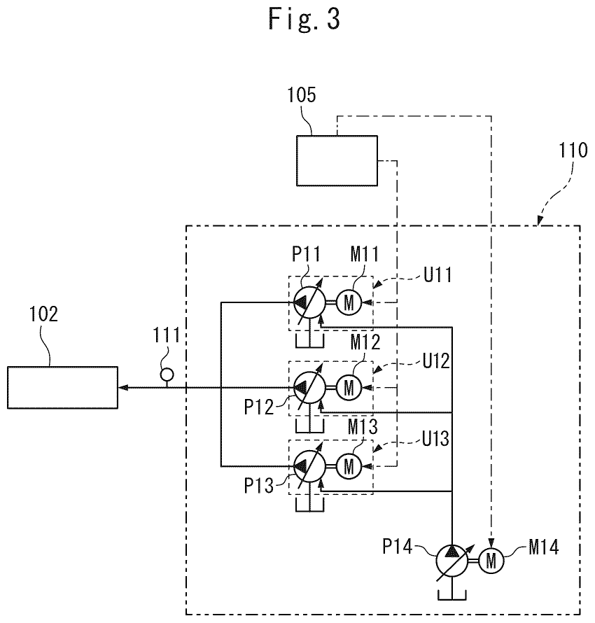

The extrusion press device 101 shown in FIG. 1 uses an extrusion mechanism 102 driven by a hydraulic pump device 110 (FIG. 3) to form an extruded product (not shown). This extrusion press device 101, as shown in the example of the configuration in FIG. 1, comprises an extrusion mechanism 102, hydraulic pump device 110, and control device 105.

### Extrusion Mechanism

The extrusion mechanism 102 extrudes a billet 103 (extrusion material) made of aluminum alloy, copper alloy, etc. from a rear side R of the extrusion press device 101 toward a front side F from the die 104. An extrusion direction “d” is shown by an arrow mark.

The extrusion mechanism 102 comprises an end platen 120 supporting the die 104, a cylinder housing 122 connected to the end platen 120 by a plurality of tie rods 121, a main cylinder 123 making a ram 124 advance, a plurality of side cylinders 125, a cross head 126 provided at the ram 124, a container 127 containing the billet 103, and a plurality of container cylinders 128.

If hydraulic fluid is supplied to the inside of the main cylinder 123 and the head 125H sides of the side cylinders 125, the cross head 126 advances toward the end platen 120. If hydraulic fluid is supplied to the rod 128L sides of the container cylinders 128, the container 127 advances and is pushed against the die 104.

Further, the extrusion mechanism 102 comprises a not shown discard cutting device. That device cuts away the discard (remaining part of billet 103) remaining at the inside of the container 127 after the extrusion step from the product by shears. The shear cylinder driving the shears is also supplied with hydraulic fluid from the hydraulic pump device 110.

When starting the extrusion step, the container cylinder 128 pushes the container 127 against the die 104, and the main cylinder 123 and side cylinders 125 make the ram 124 and cross head 126 advance toward the end platen 120 by a predetermined extrusion speed V. A stem 129 provided at the cross head 126 presses against the end face at the rear side R of the billet 103 whereby a product of a shape corresponding to the shape of the horizontal cross section of the die 104 is continuously extruded from the opening at the front side F of the die 104. Along with the progression of the extrusion step, the length of the billet 103 becomes shorter.

The speed (extrusion speed) when the stem 129 pushes the billet 103 is constant from the start to the end of the extrusion step. The extrusion speed is not changed.

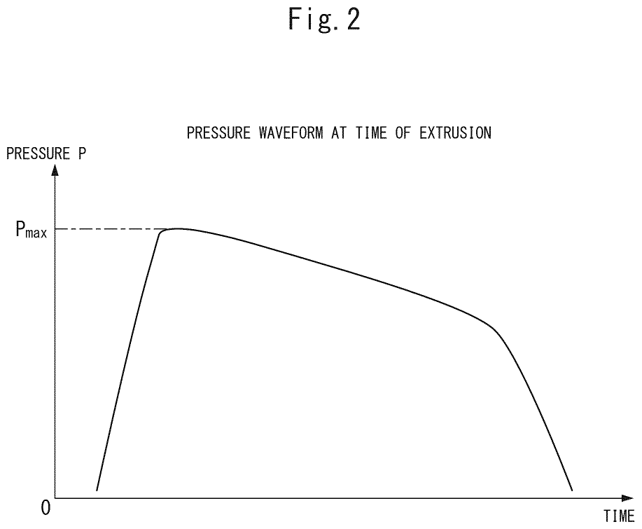

FIG. 2 shows one example of a waveform (change along with time) of a pressure P applied to the billet 103 by the hydraulic pump device 110 in the extrusion step. This waveform, in particular a required maximum pressure Pmax, differs depending on the extrusion conditions. An applied pressure P rapidly rises when the billet 103 is inserted into the inside space of the container 127 by the stem 129 and is pushed into the die 104 against the frictional force with the inside walls of the container 127. Along with the progression of the extrusion step, the length of the billet 103 becomes shorter, so the frictional force between the billet 103 and the inside walls of the container 127 decreases. For this reason, the pressure P starts to drop from the maximum value Pₘₐₓ and then gradually decreases.

If ending the extrusion step, the head 128H side of the container cylinder 128 and the rod 125L sides of the side cylinders 125 are supplied with hydraulic fluid together with the shear cylinder of the not shown discard cutting device then the operation proceeds to a standby step. This being so, the container 127 retracts to move away from the die 104, the discard is cut off, and the cross head 126 retracts toward the cylinder housing 122. The product is taken out from the die 104 and the billet 103 is placed in the container 127 for the next extrusion step.

### Hydraulic Circuit

FIG. 3 shows the hydraulic circuit. The extrusion press device 101 has three pump units (first to third pump units U11 to U13). Each of the pump units comprises a pair of a pump and motor. The first to third pump units U11 to U13 respectively have first to third pumps P11 to P13 and first to third motors M11 to M13. The pumps P11 to P13 are respectively driven by the motors M11 to M13. The first to third pump units U11 to U13 and a later explained tilt use pump P14 (and tilt use motor M14) form the hydraulic pump device 110.

There are three pump units, but it is only required that there be two or more pump units. The number is not particularly limited otherwise. For example, there may be 10 units as well.

The first to third pumps P11 to P13 are all pumps of the same specifications. The first to third motors M11 to M13 are also all motors of the same specifications. Therefore, the first to third pump units U11 to U13 all become the same specifications. This does not apply to the specifications of the tilt use pump P14 and tilt use motor M14. They may be different in specifications.

The first to third pumps P11 to P13 are all variable capacity type piston pumps. Their discharge rates can be changed by changing the tilt angles of the internal tilt plates (not shown). The tilt plates provided at the pumps P11 to P13 are tilted by hydraulic pressure of the tilt use pump P14.

The first to third pump units U11 to U13 are connected in parallel and supply hydraulic fluid to the extrusion mechanism 102 based on commands from the control device 105. At the discharge sides of the pumps P11 to P13 inside the pump units U11 to U13, pressure sensors 111 are provided. The detected pressures are output to the control device 105.

Further, the tilt use pump P14 comprises the tilt use motor M14. It is driven based on commands from the control device 105 and changes the discharge rates of the first to third pumps P11 to P13.

### Control Configuration

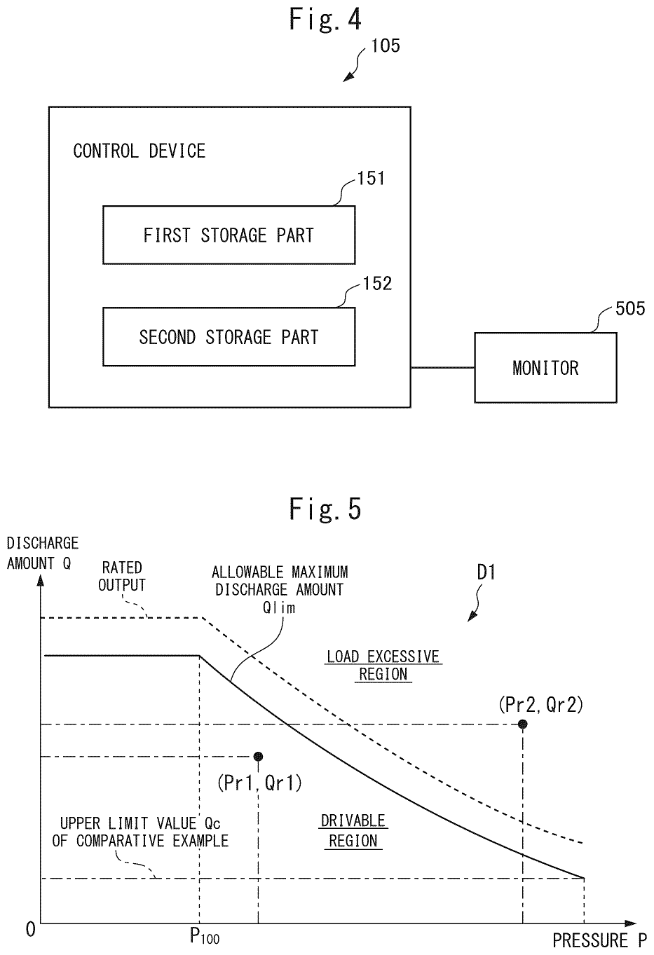

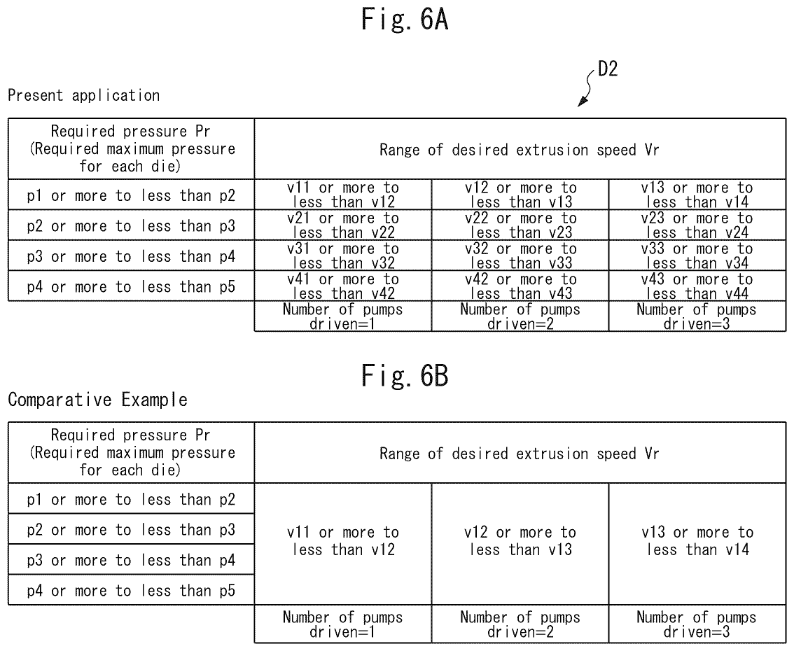

FIG. 4 shows the control configuration. The control device 105 comprises first and second storage parts 151 and 152. Further, FIG. 5 shows a map D1 provided at the first storage part 151, while FIGS. 6A and 6B show a table D2 provided at the second storage part 152.

Based on the map D1 and table D2 (both explained later) provided at the first and second storage parts 151 and 152 and the commands from the worker or preset desired extrusion conditions, the control device 105 controls the pumps P11 to P13 and motors M11 to M13. The “desired extrusion conditions” are the desired extrusion speed Vr corresponding to the die 104 used and the required pressure Pr and required discharge rate Qr corresponding to the desired extrusion speed Vr.

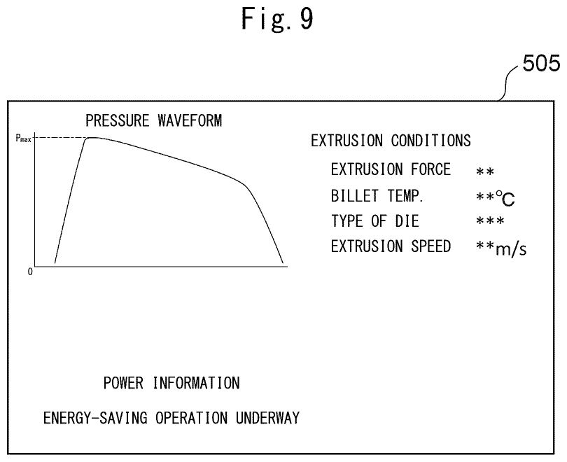

Further, the control device 105 displays on a monitor 505 the operating states of the pumps P11 to P13 and the motors M11 to M13 and the rest of the extrusion press device 101 (see FIG. 9).

### First Storage Part 151 and Map D1: FIG. 4 and FIG. 5

The first storage part 151 comprises a map D1 of a pressure-discharge rate of a pump at the extrusion step (see FIG. 5). The map D1 shows an upper limit of a discharge rate corresponding to a pump pressure (discharge pressure) (allowable maximum discharge rate Qlim). Its object is to limit the discharge rate for preventing overload of a motor. The map D1 shows the allowable maximum discharge rate Qlim per any one of first to third pumps P11 to P13.

Below, when referring to a “pump”, unless otherwise described, any one of the pumps P11 to P13 will be indicated. The same is true for the first to third pump units U11 to U13 and the first to third motors M11 to M13. References to a “pump unit” or “motor” will indicate any one of the same.

The map D1 is determined from the specifications of one pump and one motor. The output of the motor is proportional to the product of the pump pressure and the discharge rate. The graph of the pump pressure-discharge rate curves downward to the right and is set to the rated output of the motor plus a certain extra margin. The pump is a piston pump, so in the low pressure region (P100 or less of FIG. 5), the discharge rate is constant over the entire region.

Therefore, the region above Qlim shown by the curve in FIG. 5 is an excessive load region where the load of the motor becomes excessive. On the other hand, the region at the lower side from Qlim is a drivable region where the motor can be driven without being subjected to an excessive load.

Accordingly, if the desired required pressure Pr and the required discharge rate Qr are present inside the drivable region, the extrusion step can be performed without making the number of pumps driven increase (see Pr1 and Qr1 of FIG. 5). On the other hand, if the required pressure Pr and the required discharge rate Qr are present inside the excessive load region, this shows that achieving the desired extrusion requires increase of the number of pumps driven (see Pr2 and Qr2 of FIG. 5).

### Comparison With Comparative Example

FIG. 5 also shows the upper limit value of a discharge rate in a comparative example (upper limit value of discharge rate per pump). In this comparative example, regardless of the magnitude of the required pressure, the discharge rate is limited to a constant value Qc or less. Therefore, if making the desired extrusion conditions the pressure Pr1 and the discharge rate Qr1, if the discharge rate Qr1 is present in the region between the upper limit value Qc of the comparative example and the Qlim of this disclosure, in the comparative example, Qr1>Qc and Qr1 ends up exceeding the upper limit of discharge per pump, so the number of pumps driven has to be increased.

As opposed to this, in this disclosure, if within the drivable region, the discharge rate can be secured without making the number of pumps driven increase. Therefore, even if the upper limit value Qc of the comparative example was exceeded, so long as the desired pressure Pr and discharge rate Qr based on the extrusion conditions are within the drivable region, it becomes possible to continue the extrusion step without making the number of pumps driven increase.

Second Storage Part 152 and Table D2: FIG. 4 and FIGS. 6A and 6B The second storage part 152 comprises a table D2 (FIGS. 6A and 6B) determining the number of pumps driven. FIG. 6A shows the present application, while FIG. 6B shows a comparative example.

### Setting of Number of Pumps Driven in Present Application: FIG. 6A

Table D2 of FIG. 6A shows the number of pumps driven corresponding to the desired extrusion speed Vr when using the desired die 104. The number of pumps driven is determined in advance based on the extrusion conditions at the extrusion step (desired extrusion speed Vr and required pressure Pr and required discharge rate Qr required for extrusion) and stored in the second storage part 152.

Below, it is assumed that the first to third pumps P11 to P13 are parallel and the pump pressures are made the same at the pumps P11 to P13.

The maximum value Pmax of the required pressure Pr required at the extrusion step is determined for each extrusion condition (see FIG. 2). For this reason, there is nothing stopping making the maximum value Pmax of the maximum pressure the required pressure Pr.

Further, the desired extrusion speed Vr is a value set according to the extruded product. The extrusion speed is substantially proportional to the discharge rate, so if the desired extrusion speed Vr is determined, it may be deemed that the required discharge rate Qr is also determined.

Accordingly, if applying the above required pressure Pr and required discharge rate Qr at the desired die 104 to the map D1 of FIG. 5 and the Pr and Qr are present in the drivable region (for example, Pr1, Qr1 of FIG. 5), a single pump is driven. On the other hand, if the Pr and Qr are present in the excessive load region (for example, Pr2 and Qr2 of FIG. 5), the number of pumps driven is made to increase to two. If the required discharge rate Qr is not achieved even by driving two pumps, the number of pumps driven is made three.

The number of pumps driven at the desired die 104 and the desired extrusion speed Vr is determined by this. By changing the die 104 and extrusion conditions, it is possible to judge in advance the optimal numbers of pumps driven at the different dies 104 and extrusion conditions and store these as the table D2 of FIGS. 6A and 6B.

By storing in advance the numbers of pumps driven corresponding to the desired dies 104 and extrusion speeds Vr, it is possible to quickly determine the number of pumps driven. Compared to control referring to the map D1 each time to determine the number of pumps driven, the number of pumps driven can be set simply and inexpensively. In particular, if using a die 104 with a record of use in the past, by detecting the maximum pressure required by the pressure sensor 111, it becomes possible to quickly set the number of pumps driven based on the table D2.

The desired extrusion speed Vr is a value set in accordance with the extruded product and is unchanged and constant from the start to end of the extrusion step. If the desired extrusion speed Vr is constant, the required discharge rate Qr for achieving it also becomes constant from the start to end of the extrusion step.

If the desired die 104 and extrusion speed Vr are determined, the number of pumps driven is not changed until the end of the extrusion step, so complex control is not made necessary during the extrusion step. Accordingly, like in this disclosure, simple control of just reading the number of pumps driven set in advance in the table D2 is suitable.

### Comparison With Comparative Example: FIGS. 6A and 6B

In the comparative example of FIG. 6B, the number of pumps driven depends only on the desired extrusion speed Vr. The number of pumps driven is determined without regard as to the required pressure Pr. This is because, in the comparative example of FIG. 5, the upper limit value Qc is a constant value unrelated to the pressure.

Therefore, even if the required pressure Pr is low and there is leeway in the pump load, unlike this disclosure, there are cases where the number of pumps driven is increased just by the magnitude of the desired extrusion speed Vr (and required discharge rate Qr based on Vr). Compared to this disclosure, the pumps are not efficiently driven.

In FIGS. 6A and 6B, the required discharge rate Qr corresponding to the desired extrusion speed Vr is omitted. Further, the extrusion speed V is strongly correlated with the discharge rate Q, so in FIGS. 6A and 6B, instead of the desired extrusion speed Vr, the table may be prepared based on the required discharge rate Qr.

### Comparison of Numbers of Pumps Driven

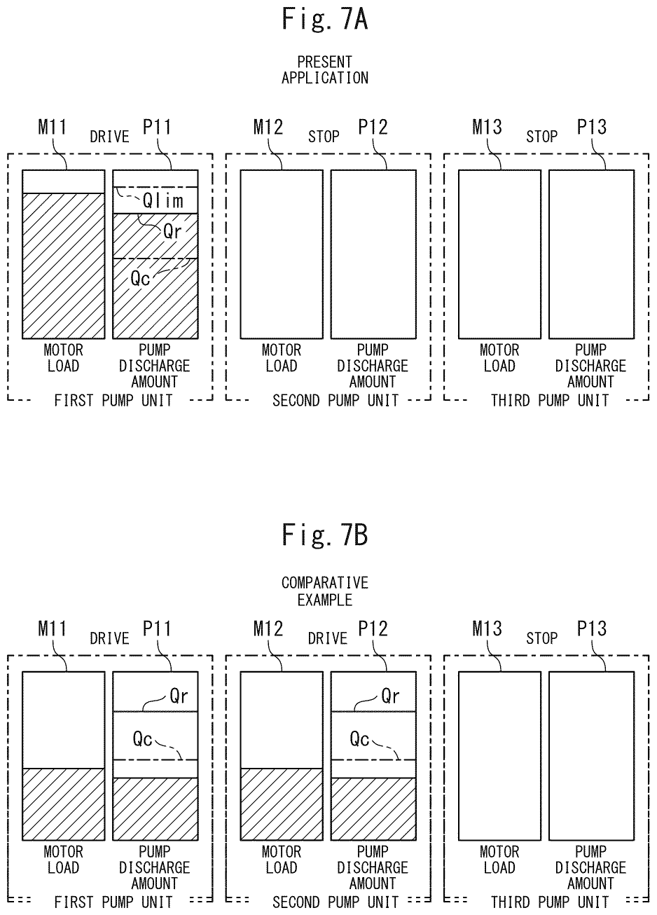

FIGS. 7A and 7B are views showing the numbers of pumps driven in the present application and the comparative example. FIG. 7A shows the present application, while FIG. 7B shows the comparative example. FIGS. 7A and 7B are a comparison under the same extrusion conditions using the same extrusion press device and die in both the present application and the comparative example. All of the extrusion conditions of the extrusion speed Vr, required pressure Pr, and required discharge rate Qr are the same.

The extrusion conditions of FIGS. 7A and 7B (extrusion speed Vr and corresponding required pressure Pr and required discharge rate Qr) are to be set in the drivable region of FIG. 5 (lower side from graph of allowable maximum discharge rate Qlim) in a region of the discharge rate upper limit value Qc or more of the comparative example. For the explanation, the examples are shown where a single pump is required for achieving the desired extrusion conditions in the present application, while two pumps are required in the comparative example.

The required discharge rate Qr corresponding to the required pressure Pr is less than or equal to the allowable maximum discharge rate Qlim in the drivable region of FIG. 5, so there is still extra capacity in the (single) motor driving the pump. Therefore, in FIG. 7A, extrusion is continued by a single pump.

On the other hand, the required discharge rate Qr exceeds the upper limit value Qc of the comparative example (see FIG. 5). For this reason, in the comparative example of FIG. 7B, to reduce the load per motor, the number of pumps (pump units) driven is made to increase. Accordingly, in the comparative example, two pumps are driven. Despite being under the same conditions, a larger number of pumps than the present application are driven.

### Extrusion Speed-Consumed Power Graph

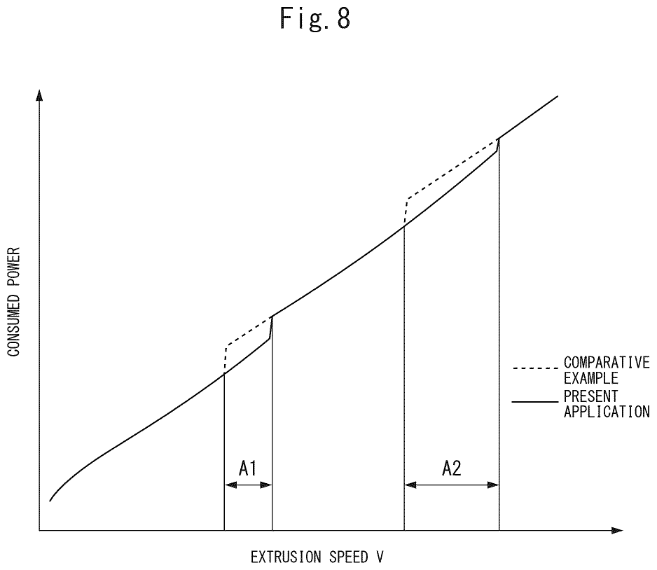

FIG. 8 is a graph showing the relationship between the extrusion speed and consumed power in the extrusion press device. The solid line shows the present application, while the broken line shows the comparative example.

At the start of the extrusion step, in both the present application and comparative example, a single pump is driven. Along with the increase of the extrusion speed, the discharge rate increases, so the motor load increases and the consumed power also rises.

If the extrusion speed is in the region A1, in the comparative example, the discharge rate exceeds the upper limit value Qc, so the number of pumps driven is increased to two (see FIG. 7B). For this reason, in the comparative example, the consumed power increases in a step manner.

On the other hand, in the present application, at the stage of the region A1, the motor load is in the drivable region (see FIG. 5) and the number of pumps driven is not increased, but left as a single pump (see FIG. 7A). Accordingly, the number of pumps driven is kept lower than the comparative example, so the consumed power also becomes lower than the comparative example.

If the extrusion speed V exceeds the region A1, in the present application as well, the motor load shifts to the excessive load region and the number of pumps driven is increased to two. In the region A2 as well, the number of pumps driven becomes three in the comparative example compared with two in the present application, so compared with the comparative example, in the present application, the consumed power is kept down.

### Advantageous Effects

(1) An extrusion press device 101 comprising a billet 103 (extrusion material), an extrusion mechanism 102 extruding the billet 103 by hydraulic pressure, first to third pump units U11 to U13 provided with first to third pumps P11 to P13 supplying hydraulic fluid to the extrusion mechanism 102 and first to third motors M11 to M13 driving the pumps P11 to P13, and a control device 105 controlling the pump units U11 to U13, wherein
in the first to third pump units provided, a map D1 showing the correlation of a discharge pressure P of each of the pumps P11 to P13 and an allowable maximum discharge rate Qlim allowed per each of the pumps P11 to P13 is provided, and
a pressure and discharge rate required when extruding the billet 103 by a desired extrusion speed Vr are respectively deemed as the required pressure Pr and required discharge rate Qr, and the control device 105 is made to increase the number of the pumps P11 to P13 driven if the required discharge rate Qr corresponding to the required pressure Pr exceeds the allowable maximum discharge rate Qlim was provided.

Due to this, even if the upper limit value Qc of the discharge rate of the comparative example (see FIG. 5) is exceeded, so long as the desired discharge rate based on the extrusion conditions is present in the drivable region, it is possible to continue the extrusion step without making the number of pumps driven increase.

In the first embodiment, variable capacity type pumps P11 to P13 were used, but so long as the individual pump units U11 to U13 can respectively integrally change their discharge rates, other types of pumps may also be used. For example, our devices and machines can be applied if, like in gear pumps, the discharge rates can be changed by changing the rotational speed. Further, the pumps may be fixed capacity types such as piston pumps and may also be vane pumps.

(2) The outputs of the motors M11 to M13 at the time of generation of the allowable maximum discharge rate Qlim were made less than or equal to the rate outputs per the single motors.

Due to this, the motors M11 to M13 can be stably driven.

(3) A table D2 determining in advance the number of pumps driven corresponding to the desired extrusion speed Vr and the required pressure Pr was made to be provided.

By storing in advance the numbers of pumps driven corresponding to the desired dies 104 and extrusion speeds Vr, it is possible to quickly determine a number of pumps to be driven. Compared to performing control referring to the map D1 to determine the number of pumps driven each time, it is possible to set the number of pumps driven simply and inexpensively. In particular, if using a die 104 with past record of use, it is possible to quickly set the number of pumps driven based on the table D2.

### Second Embodiment

Below, referring to the attached drawings, a second embodiment will be explained.

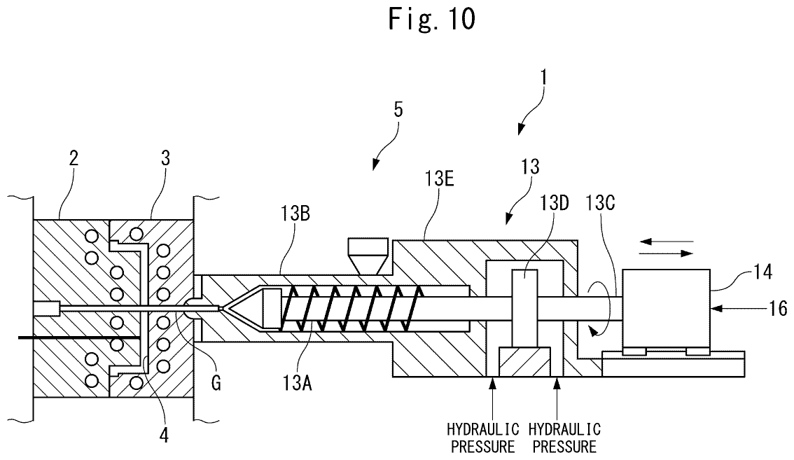

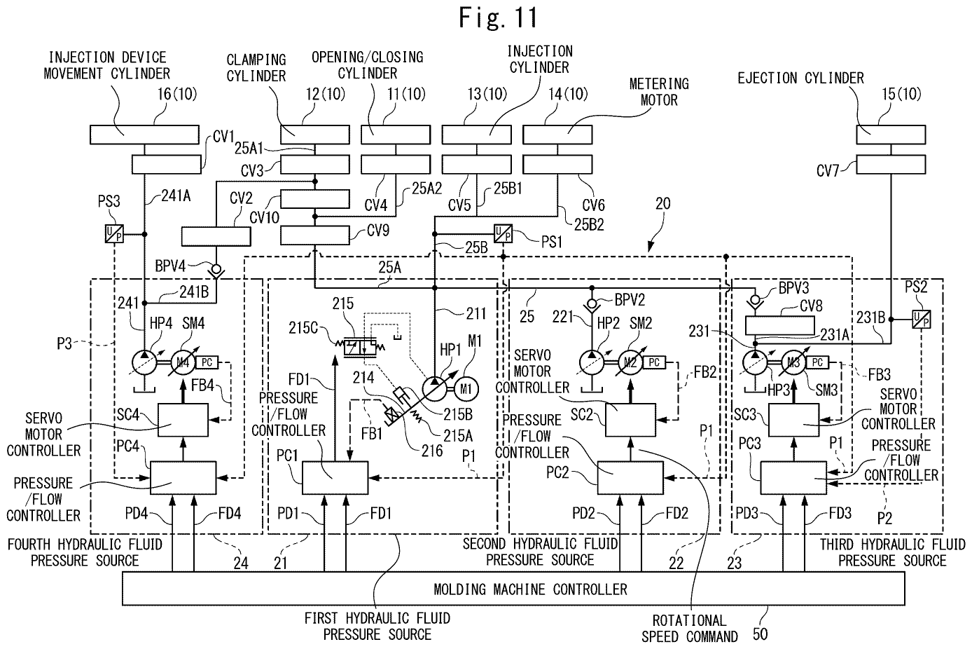

As shown in FIG. 10 and FIG. 11, the injection molding machine 1 comprises a movable mold 2 and fixed mold 3 for obtaining an article of a desired shape, an injection device 5 for injecting a molten resin as an injection material into a cavity 4 formed between the movable mold 2 and fixed mold 3, hydraulic actuators 10 for generating drive forces for performing various operations, a hydraulic supply device 20 for supplying hydraulic fluid to the hydraulic actuators 10, and a molding machine controller 50 for controlling the various components. As shown in FIG. 11, as hydraulic actuators 10, an opening/closing cylinder 11, clamping cylinder 12, injection cylinder 13, metering motor 14, ejection cylinder 15, and injection device movement cylinder 16 are provided.

### Configuration of Mold: FIG. 10

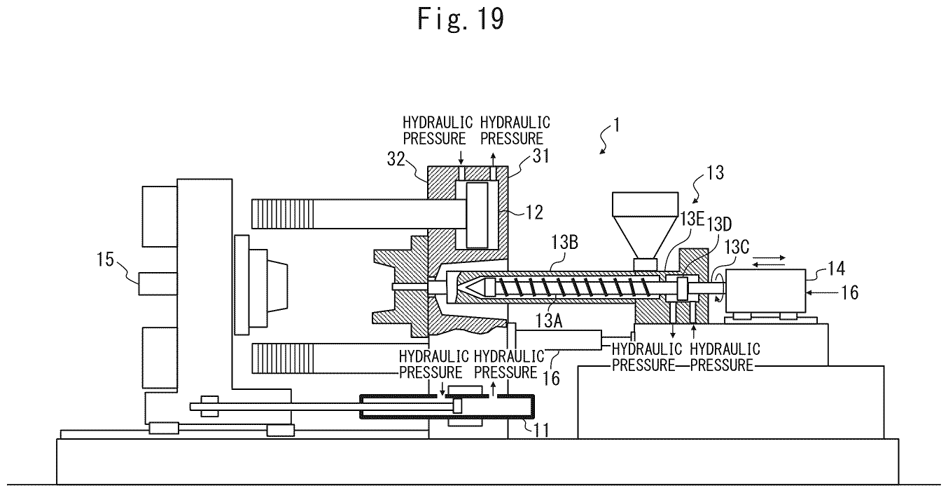

In FIG. 10, the fixed mold 3 is fixed to a fixed platen 31 of the clamping device (see FIG. 19). Further, in the clamping device, the movable mold 2 is fixed to a movable platen 32 (see FIG. 19) able to move close to or move away from the fixed platen fastening the fixed mold 3. In addition, the movable mold 2 can be changed between a closed state where it is made to approach the fixed mold 3 by operation of the opening/closing cylinder 11 to form a cavity 4 and an open state where it is moved away from the fixed mold 3. Further, the movable mold 2 and the fixed mold 3 are clamped by the clamping cylinder 12 in the closed state.

### Configuration of Injection Device: FIG. 10

As shown in FIG. 10, the injection cylinder 13 comprises an injection screw 13A, a heating tube 13B housing the injection screw 13A and able to connect to a gate G of the fixed mold 3, a connecting shaft 13C connected to a base end of the injection screw 13A, a piston 13D provided at the connecting shaft 13C, and a casing 13E connected to the base end of the heating tube 13B and housing the piston 13D. In addition, by making the piston 13D advance, the molten resin at the inside of the heating tube 13B can be made to be injected into the cavity 4 through the gate of the fixed mold 3.

Further, the metering motor 14 is coupled with the connecting shaft 13C. For this reason, by driving the metering motor 14, it becomes possible to make the injection screw 13A rotate about its axis along with the connecting shaft 13C and meter out the molten resin at the inside of the heating tube 13B. Further, the metering motor 14 is designed to be able to approach and move away from the fixed mold 3 together with the injection device 5 by the drive force of the injection device movement cylinder 16. At this time, the metering motor 14 may be either a hydraulic drive motor or an electric drive motor. Further, a not shown speed reducer may also be provided between the metering motor 14 and connecting shaft 13C. The speed reducer may be any of a gear type, pulley type, planetary type, or other type. Further, the injection molding machine 1 comprises an ejection mechanism (not shown) for ejecting and removing an article stuck to the fixed mold 3 after injection and solidification. That ejection mechanism performs an ejection operation by drive force of an ejection cylinder 15.

### Hydraulic Supply Device 20: FIG. 11

As shown in FIG. 11, the hydraulic supply device 20 comprises a first hydraulic fluid pressure source 21, second hydraulic fluid pressure source 22, third hydraulic fluid pressure source 23, and fourth hydraulic fluid pressure source 24 serving as the pressure sources of the hydraulic fluid. The hydraulic supply device 20 comprises piping routes and valves for changing to which hydraulic actuators 10 the hydraulic fluid is supplied from the first hydraulic fluid pressure source 21, second hydraulic fluid pressure source 22, third hydraulic fluid pressure source 23, and fourth hydraulic fluid pressure source 24. The components of the hydraulic supply device 20 are operated by commands of the molding machine controller 50.

The hydraulic supply device 20 comprises a merging piping 25 at which the hydraulic fluid from the first hydraulic fluid pressure source 21, second hydraulic fluid pressure source 22, and third hydraulic fluid pressure source 23 serving as pressure sources of hydraulic fluid merge, a first pressure sensor PS1 provided at a branch pipe 25B of the merging piping 25, changeover valves CV3, CV4, CV5, CV6, CV9, and CV10 to which the branch pipe 25A and branch pipe 25B of the merging piping 25 are connected and which change the supply of hydraulic fluid to some of the hydraulic actuators 10, and a changeover valve CV7 and changeover valve CV8 connected to the third hydraulic fluid pressure source 23 and changing between supply and nonsupply of hydraulic fluid to the remaining hydraulic actuators 10. The molding machine controller 50 also has the function of hydraulic control for operating and stopping the first hydraulic fluid pressure source 21, second hydraulic fluid pressure source 22, third hydraulic fluid pressure source 23, and fourth hydraulic fluid pressure source 24 in the hydraulic supply device 20 and determining the flow rates and pressures at the time of operation.

### First Hydraulic Fluid Pressure Source 21: See FIG. 11

The first hydraulic fluid pressure source 21 comprises a first motor M1 operating at a certain rotational speed, a first hydraulic pump HP1 driving the operation of the first motor MI to enable it to discharge hydraulic fluid, a first discharge piping 211 in which hydraulic fluid discharged from the first hydraulic pump HP1 flows, and a first pressure/flow controller PC1 controlling the first hydraulic pump HP1. To reduce the flow resistance of the discharged fluid flow and stabilize the discharge fluid flow control, the first discharge piping 211 is not provided with a backflow prevention valve, but if priority is given to protecting the pump rather than to reduce the flow resistance of the discharged fluid flow and stabilize the discharge fluid flow control, the first discharge piping 211 may be provided with a backflow prevention valve. The first discharge piping 211 is connected to the merging piping 25. The first motor M1, as one example, is comprised of a three-phase induction motor and operates at a constant rotational speed corresponding to the frequency of the three-phase alternating current input. The first hydraulic pump HP1 discharges a large flow rate of hydraulic fluid. The first hydraulic fluid pressure source 21 can be called the “main pressure source”. The later explained second hydraulic fluid pressure source 22, third hydraulic fluid pressure source 23, and fourth hydraulic fluid pressure source 24 only require less flow rates of hydraulic fluid at the corresponding hydraulic pumps than the first hydraulic pump HP1, so can be called “sub pressure sources”.

Further, the first hydraulic pump HP1 is a variable capacity type pump and comprises a swash plate 214 able to rotate about a center axis by a constant rotational speed by a first motor M1 and able to be changed in tilt angle with respect to the center axis, a not shown piston moving by a stroke corresponding to rotation of the swash plate 214 to discharge hydraulic fluid, an angle adjusting part 215 adjusting an angle of the swash plate 214, and an angle detector 216 detecting an angle of the swash plate 214. The angle adjusting part 215 comprises a spring 215A imparting elastic force to the swash plate 214, a hydraulic type angle adjustment use cylinder 215B changing a tilt angle of the swash plate 214 against the elastic force of the spring 215A, and an electromagnetic direction changing valve 215C controlling supply of fluid to the angle adjustment use cylinder 215B. In addition, the first pressure/flow controller PC1 controls the electromagnetic direction changing valve 215C of the angle adjusting part 215 based on the pressure command value PD1 or flow rate command value FD1 input from the molding machine controller 50 to give the predetermined pressure or flow rate, supplies the fluid to make the angle adjustment use cylinder 215B operate to adjust the angle of the swash plate 214 and, further, feedback controls the tilt angle of the swash plate 214 based on the results of detection of the angle detector 216. At this time, to raise the precision of control of the tilt angle of the swash plate 214, it is preferable to perform feedback control, but if discharging by a large flow rate such as 50% or more of the rating of the pump and not requiring fine flow control (high precision swash plate angle control), it is also possible to perform open loop control. By performing open loop control, it is possible to reduce the load of the first pressure/flow controller PC1, so it is possible to keep down the risk of mistaken operation or breakdown due to generation of heat of the first pressure/flow controller PC1 and the angle detector 216 for detecting the angle of the swash plate 214 becomes unnecessary, so it is possible to reduce the costs.

As the first motor M1 driving the first hydraulic pump HP1 of the main pressure source and discharging a large flow rate of hydraulic fluid, from the viewpoint of the high heat resistance, simple structure, ease of increase of size, good maintainability, long life, etc., a three-phase induction motor is most preferable in practice. However, a single-phase induction motor, direct current motor, synchronous motor, alternating current rectifier motor, high efficiency motor, or other motor not controlling the frequency of the current due to current switching by a power component can also be used as the first motor M1. Further, for the method of control of the speed (rotational speed) in the case of using a three-phase induction motor, it is also possible to use a method of control by an external resistance value, control by the number of poles, control by voltage, or other control by a constant rotational speed.

### Second Hydraulic Fluid Pressure Source 22: See FIG. 11

The second hydraulic fluid pressure source 22 comprises a second motor SM2 comprised of a servo motor, a servo control circuit SC2 for performing rotational speed control of the second motor SM2, a second hydraulic pump HP2 driving the operation of the second motor SM2 to enable it to discharge hydraulic fluid, a second discharge piping 221 in which hydraulic fluid discharged from the second hydraulic pump HP2 flows, a backflow prevention valve BPV2 provided at the second discharge piping 221 and restricting inflow of hydraulic fluid to the second hydraulic pump HP2, and a second pressure/flow controller PC2 controlling the second hydraulic pump HP2. The second discharge piping 221 is connected to the merging piping 25. The second hydraulic pump HP2, is comprised of a fixed capacity pump with the same discharge rate or a variable capacity pump able to be changed in discharge volume. For example, a gear pump, piston pump, vane pump, eddy pump, etc. is applied. Further, usually the sub pressure source second hydraulic pump HP2 is configured with a flow rate of hydraulic fluid smaller than the main pressure source first hydraulic pump HP1, but this disclosure is not limited to this. The flow rate of the hydraulic fluid of the second hydraulic pump HP2 may also be the same as the first hydraulic pump HP1. The same is true for the third hydraulic pump HP3 and fourth hydraulic pump HP4 as well. If desiring to make the flow rate of the main pressure source smaller because the flow rate of the hydraulic fluid mainly used is small, a large flow rate of hydraulic fluid is replenished only in steps where a particularly large flow rate is required, or other specific reason, a sub pressure source (second hydraulic fluid pressure source 22, third hydraulic fluid pressure source 23, or fourth hydraulic fluid pressure source 24) with a larger flow rate of the hydraulic fluid than the main pressure source first hydraulic pump HP1 may also be used.

Further, in the second hydraulic fluid pressure source 22, the second motor SM2 has an encoder detecting the rotational angle and outputting the detected rotational angle to the servo control circuit SC2. The second pressure/flow controller PC2 outputs the rotational speed giving a predetermined pressure or flow rate as a rotational speed command to the servo control circuit SC2 based on the pressure command value PD2 or flow rate command value FD2 input from the molding machine controller 50. The servo control circuit SC2 generates a pulse signal corresponding to the input rotational speed command value and outputs it to the second motor SM2 to make the second motor SM2 be driven to operate by a rotational speed corresponding to the rotational speed command value. The servo control circuit SC2 receives as input the rotational angle (FB2) detected by the encoder of the second motor SM2, The servo control circuit SC2 performs feedback correction based on the rotational angle while controlling the second motor SM2 to obtain the corresponding rotational speed.

As the servo motor forming the second motor SM2, due to the inexpensive cost and ease of increasing the size and increasing the output, an AC servo motor is most preferable. However, the type of the motor is not limited so long as it is a motor such as a DC servo motor, stepping motor, etc. able to be used for applications controlling the position, speed, etc. in a servo mechanism. Further, regarding the structure as well, for example, the stator structure may be either of a distributed winding type and concentrated winding type. The rotor structure may be either of a surface permanent magnet (SPM) type motor or an interior permanent magnet (IPM) type motor. However, an IPM motor gives a large amount of discharged fluid by a small sized hydraulic pump in the rotor structure, so equivalent weak magnetic field control is performed, the voltage is suppressed while in addition to the magnet torque component, the reluctance torque component can be actively utilized as an effective torque, so an IPM motor may be used when operation in a rated speed value or more high rotation region is necessary without inviting a drop in torque at the high speed region (drop in hydraulic pressure able to be generated).

### Third Hydraulic Fluid Pressure Source 23: See FIG. 11

The third hydraulic fluid pressure source 23 comprises a third motor SM3 comprised of a servo motor, a servo control circuit SC3 for performing rotational speed control of the third motor SM3, a third hydraulic pump HP3 driving the operation of the third motor SM3 to enable it to discharge hydraulic fluid, a third discharge piping 231 in which hydraulic fluid discharged from the third hydraulic pump HP3 flows, a backflow prevention valve BPV3 provided at the third discharge piping 231 and restricting inflow of hydraulic fluid to the third hydraulic pump HP3, and a third pressure/flow controller PC3 controlling the third hydraulic pump HP3. The third discharge piping 231 is connected to the merging piping 25.

In the third hydraulic fluid pressure source 23, the third motor SM3 has an encoder detecting the rotational angle and outputting the detected rotational angle to the servo control circuit SC3. The third pressure/flow controller outputs the rotational speed giving a predetermined pressure or flow rate as the rotational speed command value to the servo control circuit SC3 based on the pressure command value PD3 or flow rate command value FD3 input from the molding machine controller 50. The servo control circuit SC3 generates a pulse signal corresponding to the input rotational speed command value and outputs it to the third motor SM3 to drive operation of the third motor SM3 by a rotational speed corresponding to the rotational speed command value. The servo control circuit SC3 receives as input the rotational angle (FB3) detected by the encoder of the third motor SM3. The servo control circuit SC3 performs feedback correction of the rotational angle while controlling the third motor SM3 to give the corresponding rotational speed.

At the third hydraulic fluid pressure source 23, the third discharge piping 231 is branched into a branch pipe 231A and branch pipe 231B. The branch pipe 231A merges with the merging piping 25, while the branch pipe 231B is connected to the ejection cylinder 15. The branch pipe 231A comprises a changeover valve CV8 between the third hydraulic pump HP3 and the backflow prevention valve BPV3. In this way, the third hydraulic fluid pressure source 23 can run hydraulic fluid from the third hydraulic pump HP3 to either the branch pipe 231A or branch pipe 231B.

### Fourth Hydraulic Fluid Pressure Source 24: See FIG. 11

The fourth hydraulic fluid pressure source 24 comprises a fourth motor SM4 comprised of a servo motor, a servo control circuit SC4 for rotational speed control of the fourth motor SM4, a fourth hydraulic pump HP4 driven by rotational drive of the fourth motor SM4 to make it discharge hydraulic fluid, a fourth discharge piping 241 through which hydraulic fluid discharged from the fourth hydraulic pump HP4 flows, a backflow prevention valve BPV4 provided at the fourth discharge piping 241 and restricting inflow of hydraulic fluid to the fourth hydraulic pump HP4, and a fourth pressure/flow controller PC4 controlling the fourth hydraulic pump HP4. The fourth discharge piping 241 is not directly connected to the merging piping 25.

In the fourth hydraulic fluid pressure source 24, the fourth motor SM4 has an encoder detecting the rotational angle and outputting the detected rotational angle (FB4) to the servo control circuit SC4. The fourth pressure/flow controller PC4 outputs the rotational speed giving a predetermined pressure or flow rate as a rotational speed command value to the servo control circuit SC4 based on the pressure command value PD4 or flow rate command value FD4 input from the molding machine controller 50. The servo control circuit SC4 generates a pulse signal corresponding to the input rotational speed command value and outputs it to the fourth motor SM4 to make the fourth motor SM4 be driven to operate by a rotational speed corresponding to the rotational speed command value. The servo control circuit SC4 receives as input the rotational angle (FB4) detected by the encoder of the fourth motor SM3. The servo control circuit SC4 performs feedback correction based on the rotational angle while controlling the fourth motor SM4 to obtain the corresponding rotational speed.

At the fourth hydraulic fluid pressure source 24, the fourth discharge piping 241 is branched into a branch pipe 241A and branch pipe 241B. The branch pipe 241A is connected to the injection device movement cylinder 16 through the changeover valve CV1 while the branch pipe 241B merges with the branch pipe 25A through the changeover valve CV2. The branch pipe 241B comprises the backflow prevention valve BPV4 between the fourth hydraulic pump HP4 and the changeover valve CV2. In this way, the fourth hydraulic fluid pressure source 24 can run hydraulic fluid from the fourth hydraulic pump HP4 to either the branch pipe 241A or branch pipe 241B.

### Hydraulic Fluid Piping System: FIG. 11

The merging piping 25 has the first discharge piping 211, second discharge piping 221, and third discharge piping 231 connected to it. Hydraulic fluid can be supplied from the first hydraulic fluid pressure source 21, second hydraulic fluid pressure source 22, and third hydraulic fluid pressure source 23. Further, the merging piping 25 is branched into the branch pipe 25A and the branch pipe 25B.

The branch pipe 25A is branched into a branch pipe 25A1 and a branch pipe 25A2 and comprises the changeover valve CV9 at the upstream side from where it branched. The branch pipe 25A1 has the clamping cylinder 12 connected to it. The branch pipe 25A1 between the changeover valve CV9 and clamping cylinder 12 comprises the changeover valve CV10 and changeover valve CV3 in order from the upstream side. The branch pipe 25A2 has the opening/closing cylinder 11 connected to it through the changeover valve CV4. “Upstream” and “downstream” are defined by the orientation of flow of the hydraulic fluid.

The branch pipe 25B is branched into a branch pipe 25B1 and branch pipe 25B2. The branch pipe 25B1 has the injection cylinder 13 connected to it through the changeover valve CV5, while the branch pipe 25B2 has the metering motor 14 connected to it through the changeover valve CV6. That is, the injection cylinder 13 and metering motor 14 are supplied with hydraulic fluid from the branch pipe 25B. The branch pipe 25B comprises a first pressure sensor PS1 upstream from the changeover valve CV7. The effective pressure value P1 of the hydraulic fluid detected by the first pressure sensor PS1 is sent to the first pressure/flow controller PC1.

The third discharge piping 231 connected to the third hydraulic pump HP3 of the third hydraulic fluid pressure source 23 is branched into a branch pipe 231A and branch pipe 231B. The branch pipe 231A is merged with the merging piping 25. The branch pipe 231B is connected to the ejection cylinder 15 through the changeover valve CV7. The branch pipe 231B comprises a second pressure sensor PS2 at a downstream side of the branching point, while the effective pressure value P2 of the hydraulic fluid detected by the second pressure sensor PS2 is sent to the third pressure/flow controller PC3.

The fourth discharge piping 241 of the fourth hydraulic fluid pressure source 24 is branched into the branch pipe 241A and branch pipe 241B. The branch pipe 241A is connected to the injection device movement cylinder 16 through the changeover valve CV1. The branch pipe 241A comprises a third pressure sensor PS3 downstream from the changeover valve CV1. The effective pressure value P3 of the hydraulic fluid detected by the third pressure sensor PS3 is sent to the fourth pressure/flow controller PC4. The branch pipe 241B is connected to a branch pipe 25A1 between the changeover valve CV10 and changeover valve CV3 through the backflow prevention valve BPV4 and changeover valve CV2.

The hydraulic supply device 20 selects one or more hydraulic fluid pressure sources driven from the first hydraulic fluid pressure source 21, second hydraulic fluid pressure source 22, third hydraulic fluid pressure source 23, and fourth hydraulic fluid pressure source 24 so that the necessary amounts of hydraulic fluid are obtained at the different molding steps. It forms a supply circuit of hydraulic fluid required for performing the different molding steps by making the plurality of changeover valves operate in addition to making the hydraulic fluid discharged from the selected hydraulic fluid pressure sources merge.

When combining and merging all or any of the first hydraulic fluid pressure source 21 to third hydraulic fluid pressure source 23 to supply hydraulic fluid to the actuators, the first pressure sensor PS1 is used to detect the effective pressure value P1 of hydraulic fluid in the merging piping 25 and the detected effective pressure value is fed back to the first motor SM1, second motor SM2, and third motor SM3 for motor control.

For example, if closing the changeover valve CV2 and supplying hydraulic fluid from the fourth hydraulic fluid pressure source 24 to the injection device movement cylinder 16, the third pressure sensor PS3 is used to detect the effective pressure value P3 of the hydraulic fluid and the detected effective pressure value P3 is fed back to the fourth motor SM4 for motor control. Further, for example, if closing the changeover valve CV8 and supplying hydraulic fluid from the third hydraulic fluid pressure source 23 to the ejection cylinder 15, the second pressure sensor PS2 is used to detect the effective pressure value P2 of the hydraulic fluid and the detected effective pressure value P2 is fed back to the third motor SM3 for motor control.

That is, the hydraulic fluid from the third hydraulic fluid pressure source 23, as shown in (i) and (ii), is switched between the first pressure sensor PS1 and second pressure sensor PS2 as the place for acquisition of the effective pressure value.
(i) If the hydraulic fluid from the third hydraulic fluid pressure source 23 is made to merge with the hydraulic fluid discharged from the first hydraulic fluid pressure source 21 and second hydraulic fluid pressure source 22 and supplied to the actuators 10 for pressure control, the effective pressure value P1 detected by the first pressure sensor PS1 is fed back for control.
(ii) If the changeover valve CV8 is closed and hydraulic fluid is supplied from the third hydraulic fluid pressure source 23 to the ejection cylinder 15 for pressure control, the effective pressure value P2 detected by the second pressure sensor PS2 is fed back for control.

A “step where pressure control is required” is a step where the hydraulic actuators 10 do not have to be operated at predetermined speeds, but where the pressing force (pulling force) exerted by the hydraulic actuators has to be controlled at a predetermined value. That is, it is a step where the operating speed is not an issue. As a step where pressure control is required, mainly there are the clamping pressure raising step and the injection holding step, but if hydraulic pressure over the set hydraulic pressure upper limit value becomes required for obtaining the desired injection speed in the injection filling step, the set pressure is given priority to and speed control is switched to pressure control.

Further, a step where pressure control is not required and speed control is performed is a step where the pressing force (pulling force) exerted by the hydraulic actuators does not have to be controlled to a predetermined value, but where the actuators are made to operate by a predetermined speed.

That is, it is a step where the pressure is not an issue. As a step where speed control is required, a closing step, opening step, injection device advancing step, and injection filling step correspond to the above.

At the first hydraulic fluid pressure source 21, a first motor M1 is made to be driven to operate by a constant rotational speed to thereby make the first hydraulic pump HP1 discharge the hydraulic fluid. Further, the first hydraulic pump HP1 can be changed in volume, so by making the volume change, it is possible to adjust the discharge rate of the hydraulic fluid.

On the other hand, at the second hydraulic fluid pressure source 22 to fourth hydraulic fluid pressure source 24, it is possible to drive the second motor SM2 to fourth motor SM4 to operate to make the second hydraulic pump HP2 to fourth hydraulic pump HP4 discharge hydraulic fluid. Further, the motors for driving the second hydraulic pump HP2 to fourth hydraulic pump HP4 to operate are the second motor SM2 to fourth motor SM4, so it is possible to make the rotational speed change under the control of the servo control circuit to adjust the discharge rate of the hydraulic fluid.

In addition, the first hydraulic fluid pressure source 21, second hydraulic fluid pressure source 22, and third hydraulic fluid pressure source 23 merge by the merging piping 25 and are connected to the hydraulic actuators through the changeover valve CV2 to changeover valve CV11. Therefore, hydraulic fluid can be supplied from the first hydraulic fluid pressure source 21, second hydraulic fluid pressure source 22, and third hydraulic fluid pressure source 23 and set to the desired pressures or flow rates.

In addition, the second motor SM2 and third motor SM3 of the second hydraulic fluid pressure source 22 and third hydraulic fluid pressure source 23 are driven to operate, so it is possible to set the hydraulic fluid to the desired pressure or flow rate with a high response.

At the second hydraulic fluid pressure source 22 and third hydraulic fluid pressure source 23, the second discharge piping 221 and third discharge piping 231 connected to the merging piping 25 are provided with the backflow prevention valve BPV2 and backflow prevention valve BPV3 restricting inflow of hydraulic fluid to the second hydraulic pump HP2 and third hydraulic pump HP3. Further, the fourth discharge piping 241 at the fourth hydraulic fluid pressure source 24 comprises the backflow prevention valve BPV4 restricting inflow of hydraulic fluid to the fourth hydraulic pump HP4. Therefore, the hydraulic fluid discharged from the first hydraulic fluid pressure source 21 never flows to the second hydraulic fluid pressure source 22 to fourth hydraulic fluid pressure source 24, so even in a state where the second hydraulic pump HP2 to fourth hydraulic pump HP4 of the second hydraulic fluid pressure source 22 to fourth hydraulic fluid pressure source 24 and servo motors of the second motor SM2 to fourth motor SM4 are stopped, it is possible to supply the entire amount of the hydraulic fluid discharged from the first hydraulic fluid pressure source 21 to the hydraulic actuator 10 without leakage. Due to this, at the time of pressure control, even if the pump discharge rate becomes extremely small, by restricting the operations of the second hydraulic fluid pressure source 22 to fourth hydraulic fluid pressure source 24, it is possible to secure the pump discharge rate per hydraulic pump and, further, make the motors operate by a certain level or more of rotational speed to keep down a drop in efficiency. Further, for this reason, by making the motors operate by a low speed, it is possible to reliably prevent the temperature from becoming high and the hydraulic pumps from ending up being damaged. Furthermore, at the time of high pressure low flow rate operation where a high torque has to be output, only the first hydraulic fluid pressure source 21 is made to operate and the operations of the second hydraulic fluid pressure source 22 to fourth hydraulic fluid pressure source 24 are restricted. Due to this, in a situation at the time of a high pressure and low flow rate operation where there is no need for the amounts of fluid discharged from the second hydraulic fluid pressure source 22 to fourth hydraulic fluid pressure source 24, there is no longer a need to make the second hydraulic fluid pressure source 22 to fourth hydraulic fluid pressure source 24 operate under high load conditions. Along with this, there is no longer a need for the second motor SM2 to fourth motor SM4 for driving the second hydraulic fluid pressure source 22 to fourth hydraulic fluid pressure source 24 to be made large capacities in specifications and can be reduced in size.

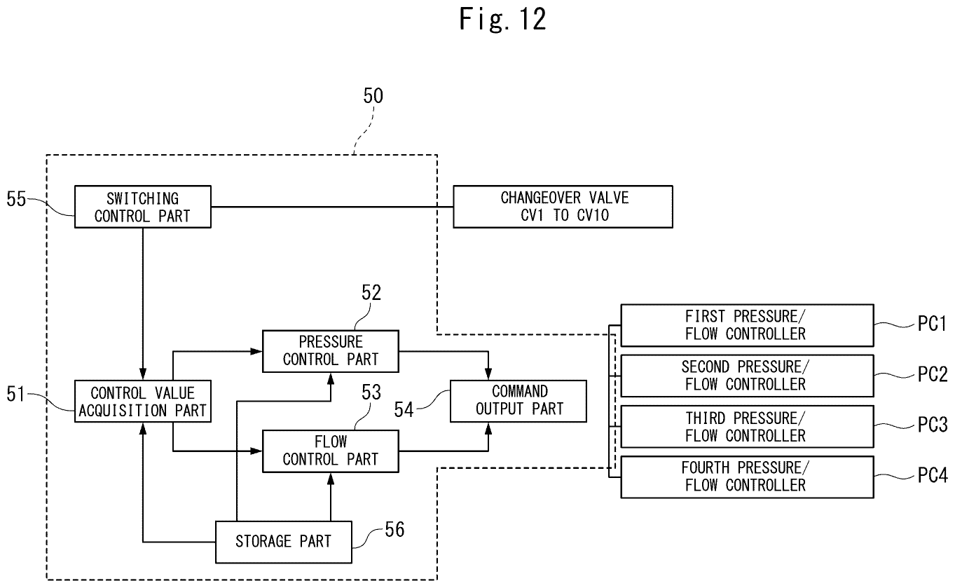

### Molding Machine Controller 50: FIG. 12

Next, the configuration of the molding machine controller 50 will be explained while referring to FIG. 12.

As shown in FIG. 12, the molding machine controller 50 serving also as the hydraulic control part in the hydraulic supply device 20 comprises a control value acquiring part 51, pressure control part 52, flow control part 53, command output part 54, switching control part 55, and storage part 56.

The control value acquiring part 51 acquires the pressure control value of the corresponding hydraulic actuator 10 and flow control value of the corresponding hydraulic actuator 10. If the pressure control value is input from the control value acquiring part 51, the pressure control part 52 generates pressure command values for the first hydraulic fluid pressure source 21, second hydraulic fluid pressure source 22, third hydraulic fluid pressure source 23, and fourth hydraulic fluid pressure source 24. If the flow control value is input from the control value acquiring part 51, the flow control part 53 generates flow rate command values for the first hydraulic fluid pressure source 21, second hydraulic fluid pressure source 22, third hydraulic fluid pressure source 23, and fourth hydraulic fluid pressure source 24. The command output part 54 outputs the pressure command value generated at the pressure control part 52 or the flow rate command value generated at the flow control part 53. The switching control part 55 controls the changeover valves CV1 to CV10. The storage part 56 stores various types of data.

### Switching Control Part 55

The switching control part 55 controls the changeover valves CV1 to CV10 based on settings input from the outside to switch connections of the corresponding hydraulic actuators 10 and pressure sources at predetermined timings. For example, at the timing of performing any one of the closing step for closing the mold, the clamping pressure raising step of clamping the mold, the metering step of metering out molten resin to be injected into the cavity 4, the injection step of injecting molten resin to inside the cavity 4, the injection holding step of holding the pressure at a predetermined pressure for a certain time period after injection, and an opening step of opening the mold, at the changeover valves CV3 to CV6, CV8, CV10, any one or selected plurality of hydraulic actuators 10 of the hydraulic actuators 10 of the opening/closing cylinder 11, clamping cylinder 12, metering motor 14, or injection cylinder 13 corresponding to the steps are connected with and rendered a state enabling input of hydraulic pressure by the first hydraulic fluid pressure source 21, second hydraulic fluid pressure source 22, and third hydraulic fluid pressure source 23.

Further, at the timing of performing any of the injection device advancing step of making the injection device 5 advance to the fixed mold 3, an ejecting step of ejecting the shaped article from the fixed mold 3, and an injection device retracting step of making the injection device 5 retract from the fixed mold 3, at the changeover valves CV1, CV2, CV7, CV8, any one of the hydraulic actuators 10 corresponding to a step of the injection device movement cylinder 16 or ejection cylinder 15 is connected with and rendered a state enabling input of hydraulic pressure by the third hydraulic fluid pressure source 23.

In the above steps, at the steps which can be simultaneously performed, the corresponding hydraulic actuators 10 can be simultaneously operated. For example, the clamping pressure raising step and advancing step can be simultaneously performed. The molding machine controller 50 may make the first hydraulic fluid pressure source 21 operate to make the clamping cylinder 12 be actuated to perform the clamping pressure raising step and may make the fourth hydraulic fluid pressure source 24 operate to make the injection device movement cylinder 16 be actuated to perform the advancing step.

### Control Value Acquiring Part 51

The control value acquiring part 51 acquires the settings input to the switching control part 55 as step information and acquires a pressure control value or flow control value corresponding to that step information from the storage part 56. The storage part 56 stores pressure control values or flow control values for obtaining the necessary drive forces by the hydraulic actuators 10 corresponding to the different steps. The control value acquiring part 51 may also acquire a pressure control value or flow control value (operating speed of the corresponding hydraulic actuator 10) which a user inputs from a control panel or other input part. If acquiring a pressure control value, the control value acquiring part 51 outputs the pressure control value acquired by the pressure control part 52 and step information. On the other hand, if acquiring a flow control value, the control value acquiring part 51 outputs the flow control value acquired by the flow control part 53 and step information.

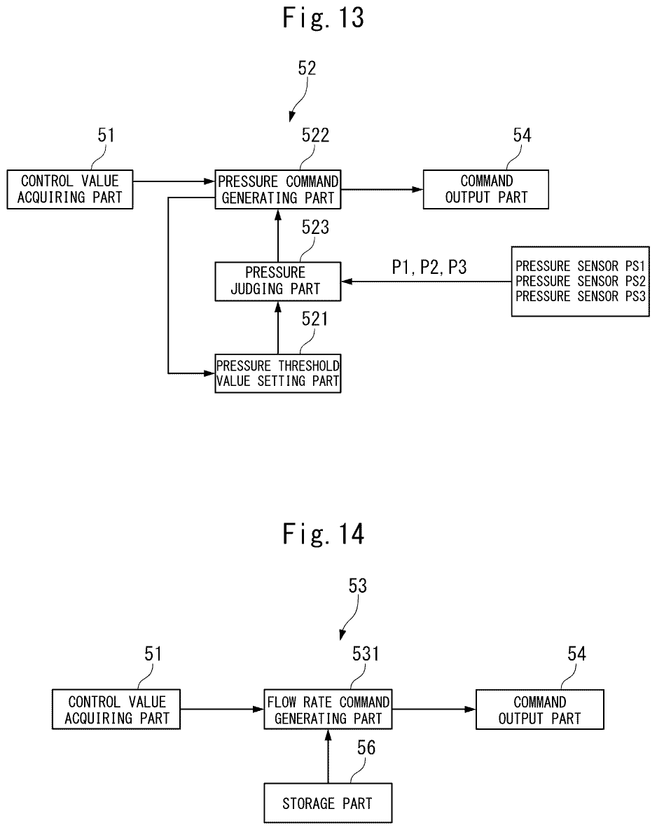

### Pressure Control Part 52: FIG. 13

Next, the pressure control part 52 will be explained while referring to FIG. 13.

The pressure control part 52 comprises a pressure threshold value setting part 521 for setting pressure threshold values lower than pressure control values linked with the first hydraulic fluid pressure source 21 to fourth hydraulic fluid pressure source 24 based on the pressure control values, a pressure command value generating part 522 generating and outputting pressure command values PD1, PD2, PD3, PD4 corresponding to the pressure control values, and a pressure judging part 523 judging whether pressures of hydraulic fluid detected by the first pressure sensor PS1 to third pressure sensor PS3 are greater than or equal to the pressure threshold values set by the pressure threshold value setting part 521, the pressure judging part 523 receiving as input effective pressure values P1, P2, P3 detected by the first pressure sensor PS1 to third pressure sensor PS3.

In the rotational speed control of servo motors, the molding machine controller 50 enters the pressure command values PD1 to PD4 for the pressure sources and the effective pressure values P1 to P3 of the hydraulic fluid detected by the first pressure sensor PS1 to third pressure sensor PS3 set on the circuit into the first pressure/flow controller PC1 to fourth pressure/flow controller PC4 and compares the pressure command values PD1 to PD4 and the effective pressure values P1 to P3 to control the rotational speeds of the servo motors of the pressure sources. The rotational speed control is divided into the following three parts:
Pressure command values PD1 to PD4>Effective pressure values P1 to P3
Pressure command values PD1 to PD4≈Effective pressure values P1 to P3
Pressure command values PD1 to PD4<Effective pressure value P1 to effective pressure value P3.

Pressure command value>Effective pressure value: Make servo motor of that pressure source operate to discharge hydraulic fluid.

Pressure command value~Effective pressure value: Make servo motor operate at low speed to discharge hydraulic fluid to make up for internal leakage at circuit or first hydraulic pump HP1 to fourth hydraulic pump HP4 so that effective pressure value becomes as shown by pressure command value.

Pressure command value<Effective pressure value: Stop operation of servo motor to not discharge hydraulic fluid.

### Flow Control Part 53: FIG. 14

Next, the flow control part 53 will be explained.

As shown in FIG. 14, the flow control part 53 has a flow rate command value generating part 531 referring to a table stored in the storage part 56 and generating flow rate command values corresponding to the first hydraulic fluid pressure source 21 to fourth hydraulic fluid pressure source 24 based on the flow control values. Rather than refer to the table stored in the storage part 56, the flow control part 53 may also generate flow rate command values by a processing formula in which flow control values and flow rate command values are linked.

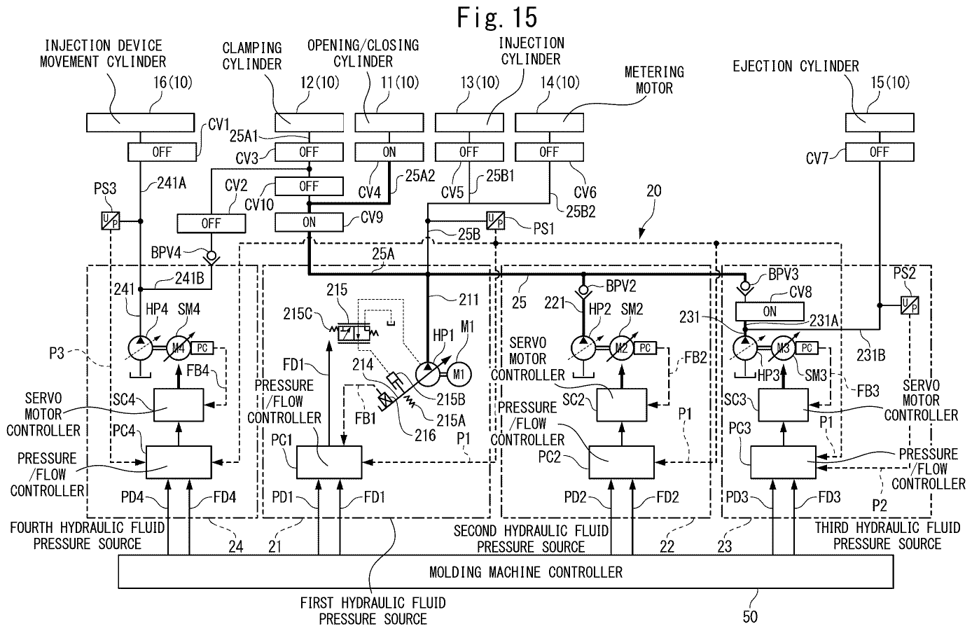

### Operation of Hydraulic Supply Device 20: FIG. 15 to FIG. 18

Next, referring to FIG. 15 to FIG. 18, the supply route of hydraulic fluid in the hydraulic supply device 20 will be explained for each step. This explanation will be given in the order of the closing step, clamping pressure raising step, injection device advancing step, metering step, injection step (injection pressure holding step), and ejection step.

### Closing Step (Opening/Closing Cylinder 11): Speed Control (FIG. 15)

Referring to FIG. 15, the supply route of hydraulic fluid in the hydraulic supply device 20 in the closing step will be explained. In FIG. 15 to FIG. 18, the types of piping through which the hydraulic fluid flows are shown by bold lines. Further, an open changeover valve is displayed as “ON” while a closed changeover valve is indicated as “OFF”.

The closing step, together with the opening step, requires operating the movable platen at a high speed to shorten the molding cycle, so speed control is employed. Speed control is similarly employed for the injection device advancing step, metering step, and injection filling step where high speed movement is required.

In the closing step, hydraulic fluid is supplied to the opening/closing cylinder 11. The opening/closing cylinder 11 is supplied with hydraulic fluid from the first hydraulic fluid pressure source 21, second hydraulic fluid pressure source 22, and third hydraulic fluid pressure source 23 toward the merging piping 25. At this time, the first hydraulic fluid pressure source 21, second hydraulic fluid pressure source 22, and third hydraulic fluid pressure source 23 are controlled using the effective pressure value P1 by the first pressure sensor PS1.

In the closing step, the changeover valve CV4, changeover valve CV8, and changeover valve CV9 are opened so that hydraulic fluid flows (in figures, ON) while the other changeover valves are closed so that flow of hydraulic fluid is stopped (in figures, OFF). Below, only the notations will be listed.
Open: CV4, CV8, CV9
Closed: CV1, CV2, CV3, CV5, CV6, CV7, CV10 In the clamping pressure raising step driving the clamping cylinder 12, the injection step driving the injection cylinder 13, the metering step driving the metering motor 14, and the opening step driving the opening/closing cylinder 11 as well, in the same way as the closing step, the first hydraulic fluid pressure source 21, second hydraulic fluid pressure source 22, and third hydraulic fluid pressure source 23 are used to supply hydraulic fluid toward the merging piping 25. However, by controlling the opening/closing of the changeover valves, the final destinations of supply of hydraulic fluid of the opening/closing cylinder 11, clamping cylinder 12, and metering motor 14 are determined.

In the opening/closing step driving the opening/closing cylinder 11 and the metering step driving the metering motor 14, the fourth hydraulic fluid pressure source 24 is not used. However, in the clamping pressure holding step after the clamping pressure raising step, the first hydraulic fluid pressure source 21 to third hydraulic fluid pressure source 23 can be stopped and the hydraulic fluid supplied to the clamping cylinder 12 can be changed to only hydraulic fluid from the fourth hydraulic fluid pressure source 24. In the clamping pressure holding step, it is also possible to control the discharge pressure of the fourth hydraulic fluid pressure source 24 based on the effective pressure value P3 at the third pressure sensor PS3 to adjust the clamping holding pressure.

In the closing step shown in FIG. 15, if switching the speed of movement of the movable platen 32 (see FIG. 19) in multiple stages, the switching positions of the speeds have to be precisely controlled. Sometimes the first, second, and third hydraulic pumps HP1, HP2, and HP3 at the first, second, and third hydraulic fluid pressure sources 21, 22, 23 are driven or stopped according to need. Accordingly, the desired effect, which controls the discharge rates of the plurality of pumps while optimizing the number of pumps driven, is preferable.

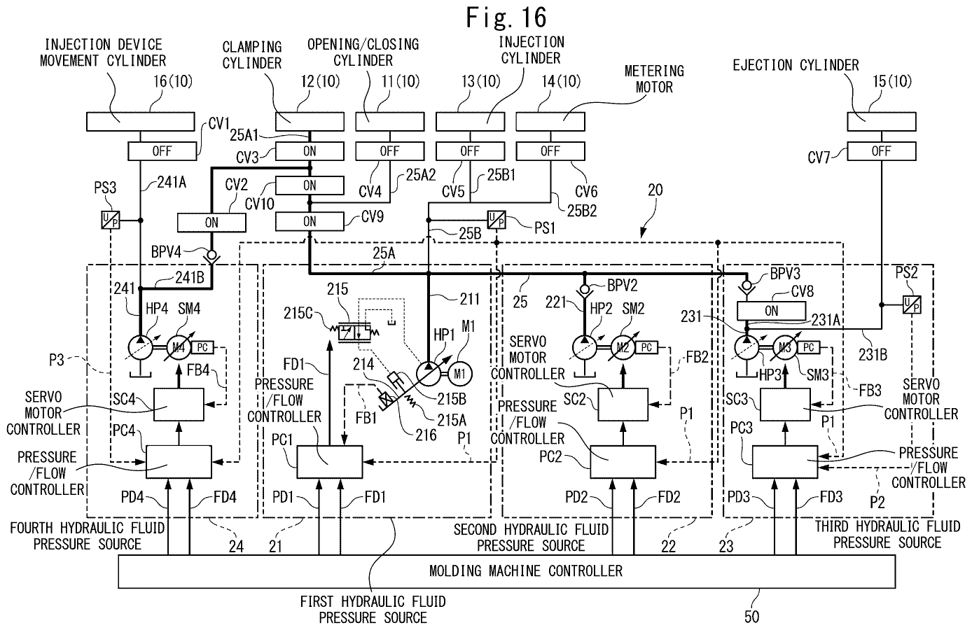

### Clamping Pressure Raising Step (Clamping Cylinder 12): Pressure Control (FIG. 16)

In the clamping pressure raising step, the clamping cylinder 12 is supplied with hydraulic fluid. The clamping pressure raising step is controlled in pressure to apply a predetermined clamping force for clamping from a state after the mold finishes being closed by the closing step and the fixed mold and movable mold closely contact each other. The clamping pressure raising step is a step where the pressure is the highest and a large flow rate of hydraulic fluid is required since the pressure receiving area of the clamping cylinder (cylinder inside diameter) in the injection molding machine 1 is the largest.

The hydraulic fluid in the clamping pressure raising step is supplied from the first hydraulic fluid pressure source 21, second hydraulic fluid pressure source 22, and third hydraulic fluid pressure source 23 through the branch pipe 25A of the merging piping 25 and from the fourth hydraulic fluid pressure source 24 through the branch pipe 241B. At this time, in addition to the hydraulic fluid from the first hydraulic fluid pressure source 21 to third hydraulic fluid pressure source 23, the hydraulic fluid from the fourth hydraulic fluid pressure source 24 is simultaneously supplied to the clamping cylinder 12 because when switching to the clamping pressure holding step following right after the clamping pressure raising step is completed, if making the hydraulic fluid from the first hydraulic fluid pressure source 21 to third hydraulic fluid pressure source 23 stop and newly starting supply of hydraulic fluid from the fourth hydraulic fluid pressure source 24, the hydraulic pressure is liable to be cut off and shock to occur when switching hydraulic fluid. To switch the hydraulic pressure of the clamping cylinder 12 to the clamping pressure holding step smoothly without break as the raised fluid pressure, it is effective to supply hydraulic fluid from the fourth hydraulic fluid pressure source 24 to the clamping cylinder in the clamping pressure raising step as well. The first hydraulic fluid pressure source 21 to fourth hydraulic fluid pressure source 24 are controlled by pressure control. The route of the piping through which the hydraulic fluid flows is as shown in FIG. 16. The operations of the changeover valves are as listed below: The third hydraulic fluid pressure source 23 is controlled based on the effective pressure value P1 by the first pressure sensor PS1.
Open: CV2, CV3, CV10, CV9, CV8
Closed: CV1, CV4, CV5, CV6, CV7

In the clamping pressure raising step shown in FIG. 16, the clamping force or the inching speed of the movable platen 32 (see FIG. 19) at the time of injection compression molding etc. have to be precisely controlled. The first, second, and third hydraulic pumps HP1, HP2, HP3 at the first, second, and third hydraulic fluid pressure sources 21, 22, 23 sometimes are driven or stopped in accordance with need. Accordingly, the desired effect of controlling the discharge rates of a plurality of pumps while optimizing the number of pumps driven becomes more remarkable.

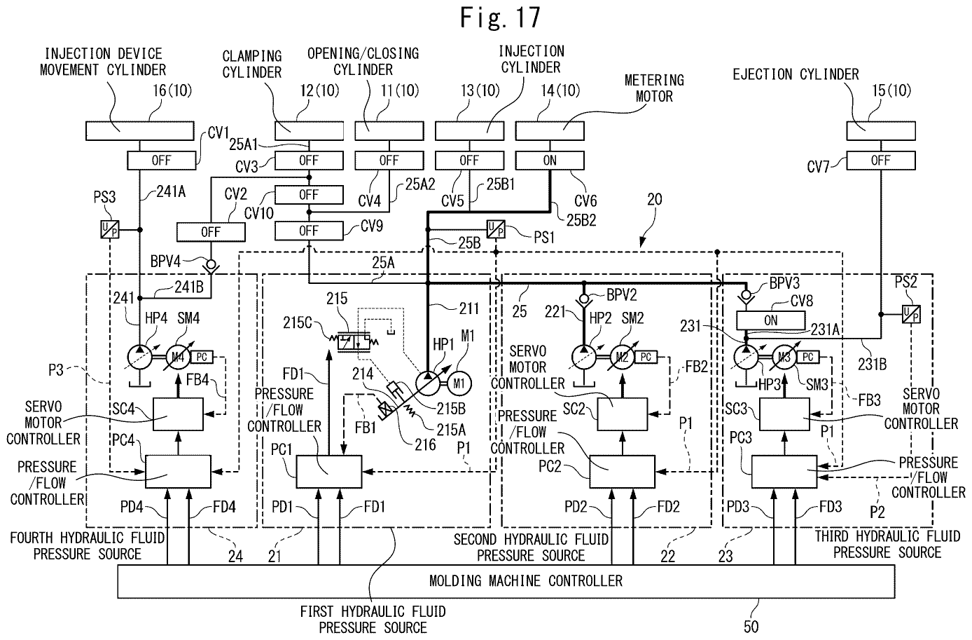

### Metering Step (Metering Motor 14): Speed Control (FIG. 17)

In the metering step, hydraulic fluid is supplied to the metering motor 14.

Hydraulic fluid is supplied to the metering motor 14, as explained above, from the first hydraulic fluid pressure source 21, second hydraulic fluid pressure source 22, and third hydraulic fluid pressure source 23 through the merging piping 25, branch pipe 25B, and branch pipe 25B2. The first hydraulic fluid pressure source 21 to third hydraulic fluid pressure source 23 are controlled in the same way as the closing step explained above, so here the explanation will be omitted, but the route of the piping through which the hydraulic fluid flows is shown in FIG. 17 and the operations of the changeover valves are listed below:
Open: CV6, CV8
Closed: CV5, CV9(CV1, CV2, CV3, CV4, CV7, CV10)

In the metering step shown in FIG. 17, the amount of molten resin has to be precisely controlled. The first, second, and third hydraulic pumps HP1, HP2, HP3 at the first, second, and third hydraulic fluid pressure sources 21, 22, 23 sometimes are driven or stopped in accordance with need. Accordingly, the desired effect of controlling the discharge rates of a plurality of pumps while optimizing the number of pumps driven becomes more remarkable.

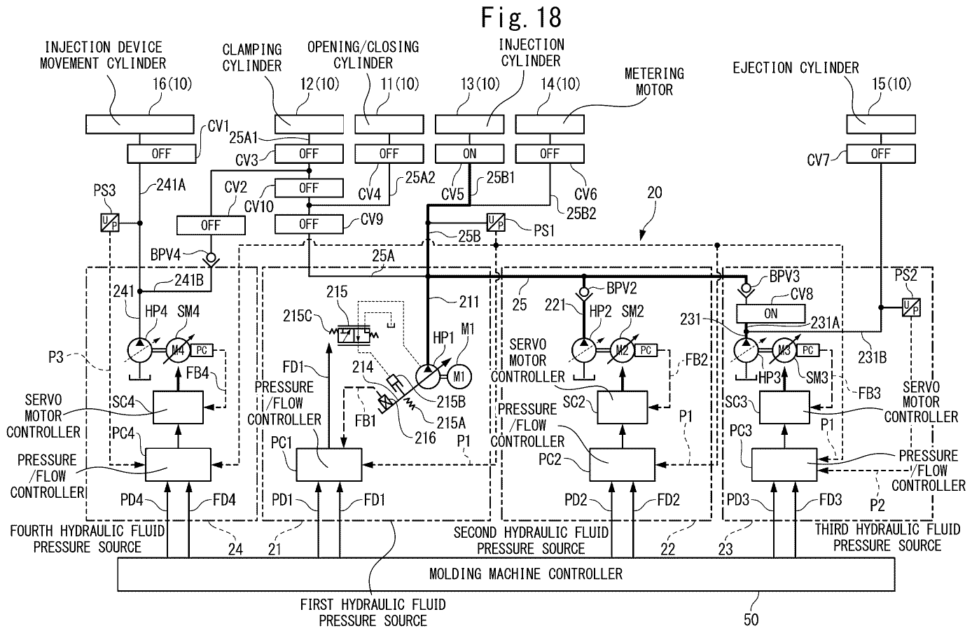

### Injection Filling Step: (Injection Cylinder 13): Speed Control (FIG. 18)

In the injection filling step, hydraulic fluid is supplied to the injection cylinder 13.

Hydraulic fluid is supplied in the injection filling step, as explained above, from the first hydraulic fluid pressure source 21, second hydraulic fluid pressure source 22, and third hydraulic fluid pressure source 23 through the branch pipes 25B1 and 25B2 of the merging piping 25.

In the operation for injecting the resin and filling it in the cavity at a high speed, to cause the injection cylinder 13 to operate by a set injection operation speed, the first hydraulic fluid pressure source 21 to third hydraulic fluid pressure source 23 are all controlled by the respectively assigned discharge flow rates (motor rotational speeds). Further, the first hydraulic fluid pressure source 21, second hydraulic fluid pressure source 22, and third hydraulic fluid pressure source 23 are controlled based on the effective pressure value P1 of the first pressure sensor PS1.

In addition, the first hydraulic fluid pressure source 21 to third hydraulic fluid pressure source 23 are controlled in the same way as the opening step explained above, so here the explanation will be omitted, but the route of the piping through which the hydraulic fluid flows is shown in FIG. 18 and the operations of the changeover valves are listed below:
Open: CV5, CV8
Closed: CV1, CV2, CV3, CV4, CV6, CV7, CV9, CV10

### Injection Holding Step (Injection Cylinder 13): Pressure Control (FIG. 18)

The injection holding step maintains and bears a predetermined pressure of molten resin to push the surface of the shaped article against the cavity wall surfaces by the pressure of the molten resin remaining at the center part of thickness even if the molten resin cools and solidifies and the resin near the cavity wall surfaces tries to shrink in volume and to replenish the molten resin by exactly an amount commensurate with the shrinkage of volume (compensating flow).

In the injection holding step as well, hydraulic fluid is supplied to the injection cylinder 13. Therefore, in the injection holding step, the hydraulic fluid is supplied in the same way as the injection filling step, so here the explanation will be omitted.

In the injection filling step and the injection holding step shown in FIG. 18 as well, the first, second, and third hydraulic pumps HP1, HP2, HP3 are driven or stopped in accordance with need in the same way as the above-mentioned metering step (FIG. 17) for the purpose of precisely controlling the amount of the molten resin, so the desired effect, which optimizes the number of pumps driven, is preferable.

### Effects Exhibited by Injection Molding Machine 1

### Ensuring Precision of Operational Control and Saving Space and Lowering Costs

The hydraulic supply device 20 in the injection molding machine 1 comprises mutually independently driven second hydraulic pump HP2 and third hydraulic pump HP3. Therefore, precision of operational control can be ensured.

Further, the hydraulic supply device 20 can supply hydraulic fluid from the second hydraulic pump HP2 and third hydraulic pump HP3 merged at the merging piping 25 when high pressure and a large flow rate are required and can supply hydraulic fluid from only the third hydraulic pump HP3 when high pressure and a large flow rate are not required. Therefore, the hydraulic supply device 20 need only be provided with the single first hydraulic fluid pressure source 21 as the main pressure source, so space can be saved and costs can be lowered. In particular, when a high pressure and large flow rate are required, the parts of the hydraulic fluid from the first hydraulic pump HP1, second hydraulic pump HP2, third hydraulic pump HP3, and fourth hydraulic pump HP4 are drawn upon and made to merge at the merging piping 25, so space can be saved and costs can be lowered.

### Reduction of Amount of Hydraulic Fluid Etc.

The third hydraulic pump HP3 of the third hydraulic fluid pressure source 23 performs the two functions of a pump for supply of hydraulic fluid to the merging piping 25 requiring a large flow rate and a dedicated pump for making the ejection cylinder 15 requiring just a small flow rate operate simultaneously with the hydraulic actuators communicated with the merging piping 25. Therefore, the injection molding machine 1 can be decreased in number of sub hydraulic pumps, so the amount of hydraulic fluid of the molding machine as a whole can be reduced.

### Advantageous Effects Due to Reduction of Number of Pumps

By decreasing the number of pumps in this way, the injection molding machine 1 further exhibits the following effects.

If the number of pumps decreases, it is possible to decrease the operating sound of the pumps by that amount.

If the number of pumps decreases, it is possible to decrease the piping through which the hydraulic fluid discharged from the pumps runs and the joints of the piping and thereby decrease the risk of fluid leakage.

If the number of pumps decreases, it is possible to decrease the motors driving the pumps, so the consumed power can be reduced.

In addition to the above, so long as not deviating from the scope of this disclosure, it is possible to selectively adopt and delete the configurations explained in the above embodiments and possible to suitably change them to other configurations In the second embodiment as well, it is possible to obtain actions and effects similar to the effects (1) to (3) of the first embodiment. In addition, in the second embodiment, the actions and effects described in the following (1) to (6) can be obtained.

According to an aspect (1) according to the second embodiment, there is provided an injection molding machine provided with a plurality of hydraulic actuators and a hydraulic supply device supplying hydraulic fluid to the hydraulic actuators and performing injection molding by making the hydraulic actuators operate, in which injection molding machine,
the hydraulic supply device provided with
a second hydraulic pump discharging the hydraulic fluid by being driven to operate by a second servo motor and a third hydraulic pump discharging the hydraulic fluid by being driven to operate by a third servo motor,
a merging piping at which the hydraulic fluid from the second hydraulic pump and the hydraulic fluid from the third hydraulic pump merge and through which the hydraulic fluid flows toward a first actuator among a plurality of hydraulic actuators,
third discharge piping through which the hydraulic fluid from the third hydraulic pump flows toward a second actuator not included in the first actuator,
a changeover valve able to change a flow path supplying hydraulic fluid discharged from the third hydraulic pump to either a flow path to the merging piping or a flow path to the third discharge piping, and
a first pressure sensor provided at the merging piping and a second pressure sensor provided at the third discharge piping.

According to an aspect (2),
the hydraulic supply device comprises
a fourth hydraulic pump discharging the hydraulic fluid by being driven to operate by a fourth servo motor,
fourth discharge piping through which the hydraulic fluid from the fourth hydraulic pump flows toward a third actuator not included in the first actuator,
a changeover valve able to change a flow path supplying hydraulic fluid discharged from the fourth hydraulic pump to either a flow path to the merging piping or a flow path to the fourth discharge piping, and
a third pressure sensor is provided at the fourth discharge piping.

According to an aspect (3),
in the hydraulic supply device, switching control is possible to
control the third servo motor based on the first pressure sensor if supplying the hydraulic fluid discharged from the third hydraulic pump to the merging piping and
control the third servo motor based on the second pressure sensor if supplying the hydraulic fluid discharged from the third hydraulic pump to the third discharge piping.

According to an aspect (4),
in the hydraulic supply device, switching control is possible to
control the fourth servo motor based on the first pressure sensor if supplying the hydraulic fluid discharged from the fourth hydraulic pump to the first actuator and
control the fourth servo motor based on the third pressure sensor if supplying the hydraulic fluid discharged from the fourth hydraulic pump to the third actuator.

According to an aspect (5),
the hydraulic supply device further comprises a first hydraulic pump driven to discharge hydraulic fluid by driving operation of a first motor operating at a constant rotational speed, and
when running hydraulic fluid toward the first actuator through the merging piping,
the hydraulic fluid from the first hydraulic pump, second hydraulic pump, third hydraulic pump, and fourth hydraulic pump is made to merge at the merging piping.

According to an aspect (6),
the first actuator comprises at least an opening/closing cylinder, clamping cylinder, injection cylinder, and metering motor,
the second actuator comprises an ejection cylinder,
the third actuator comprises an injection device movement cylinder,
at least the opening/closing cylinder, clamping cylinder, injection cylinder, and metering motor are supplied with hydraulic fluid through the merging piping.

### Other Examples

Above, as our devices and machines, a first embodiment (extrusion press device) and second embodiment (injection molding machine) were described, but this disclosure may also be applied to other apparatuses. For example, this disclosure can also be applied to any apparatus having a plurality of pumps able to be changed in discharge rate in a die cast machine etc.

What is claimed is:

1. An extrusion press device comprising:
an extrusion material,
an extrusion mechanism extruding the extrusion material by hydraulic pressure,
pump units comprising pumps supplying hydraulic fluid to the extrusion mechanism and motors driving the pumps, and
a control device controlling the pump units,
in which extrusion press device,
in a plurality of pump units provided, correlation is established between a discharge pressure of each pump and an allowable maximum discharge rate allowed per each pump,
a pressure and discharge rate required when extruding the extrusion material by a desired extrusion speed are respectively deemed as the required pressure and required discharge rate, and
the control device is made to increase the number of the pumps driven if the required discharge rate corresponding to the required pressure exceeds the allowable maximum discharge rate.

2. The extrusion press device according to claim 1, wherein outputs of the motors at a time of occurrence of the allowable maximum discharge rate are a rated output per motor or less.

3. The extrusion press device according to claim 1, which extrusion press device further comprises a table in which the number of pumps driven corresponding to the desired extrusion speed and the required pressure is set in advance.

4. An injection molding machine comprising:
an injection material,
an injection device injecting the injection material by hydraulic pressure,
pump units comprising pumps supplying hydraulic fluid to the injection device and motors driving the pumps, and
a control device controlling the pump units,
in which injection molding machine,
in a plurality of pump units provided, correlation is established between a discharge pressure of each pump and an allowable maximum discharge rate allowed per each pump,
a pressure and discharge rate required when injecting the injection material by a desired injection speed are respectively deemed as the required pressure and required discharge rate, and
the control device is made to increase the number of the pumps driven if the required discharge rate corresponding to the required pressure exceeds the allowable maximum discharge rate.

5. The injection molding machine according to claim 4, wherein outputs of the motors at a time of occurrence of the allowable maximum discharge rate are a rated output per motor or less.

6. The injection molding machine according to claim 4, which injection molding machine further comprises a table in which the number of pumps driven corresponding to the desired injection speed and the required pressure is set in advance.
